(19) United States
(12) Patent Application Publication
(10) Pub. No.: US 2009/0063842 A1
(43) Pub. Date: Mar. 5, 2009

(54) PRINTER

(75) Inventor: Osamu AZAMI, Shiojiri-shi (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Tokyo (JP)

(21) Appl. No.: 12/198,984

(22) Filed: Aug. 27, 2008

(30) Foreign Application Priority Data
Aug. 27, 2007 (JP) 2007-219478

(51) Int. Cl. G06F 9/06; H04L 9/06; G06F 9/445

(52) U.S. Cl. 713/2; 380/277; 717/168

(57) ABSTRACT

A printer includes: a nonvolatile storage unit, storing a plurality of types of software and enable keys for the respective pieces of the software; and a software update unit, when update information including several pieces of software and verification keys and new enable keys for the respective pieces of the software is provided, determining, whether or not the enable key in the nonvolatile storage unit pertaining to the corresponding software has a predetermined relationship with the verification key in the update information, with respect to each of the pieces of the software in the update information, and performing rewrite processing for rewriting the software and the enable key in the nonvolatile storage unit respectively to the software and the new enable key in the update information, with respect to each of the pieces of the software for which the enable key has the predetermined relationship with the verification key.

### BACKGROUND

1. Technical Field

The present invention relates to a printer capable of updating software including firmware and set data.

2. Related Art

A related-art printer is implemented as a device having a function (hereinafter described as an “update function”) of updating various types of software, which includes firmware and set data, installed in the device in accordance with received data or data on a portable recording medium attached to the device. Specifically, the related-art printer is embodied as a device that can simply undergo correction of a malfunction, functional improvements, and the like without a necessity of sending a device to a manufacturer. However, the update function of such printer is realized as a function of updating software, so long as a version update (upgrade) is available (see, for instance, JP-A-2001-51844).

Therefore, the related-art printer has become a device that might update software which should not be updated (e.g., software that is not provided for the common user and that has been developed for a specific client).

### SUMMARY

An advantage of some aspects of the invention is to provide a printer capable of updating various types of software more accurately so as not to update software that should not be updated.

According to an aspect of the invention, there is provided a printer comprising:

a nonvolatile storage unit, storing a plurality of types of software and enable keys for the respective pieces of the software; and

a software update unit, when update information including several pieces of software and verification keys and new enable keys for the respective pieces of the software is provided,
determining, whether or not the enable key in the nonvolatile storage unit pertaining to the corresponding software has a predetermined relationship with the verification key in the update information, with respect to each of the pieces of the software in the update information, and
performing rewrite processing for rewriting the software and the enable key in the nonvolatile storage unit respectively to the software and the new enable key in the update information, with respect to each of the pieces of the software for which the enable key has the predetermined relationship with the verification key.

The present disclosure relates to the subject matter contained in Japanese patent application No. 2007-219478 filed on Aug. 27, 2007 which is expressly incorporated herein by reference in its entirety.

### BRIEF DESCRIPTION OF THE DRAWINGS

The invention will be described with reference to the accompanying drawings, wherein like numbers reference like elements.

FIG. 1 is a block diagram of a printer of an embodiment.

FIG. 2 is a descriptive view of a data configuration of an update package processed by the printer of the embodiment.

FIG. 3 is a flowchart of update processing executed by the printer of the embodiment.

FIG. 4 is a view showing an example of operation performed at the time of an update of software of the printer of the embodiment.

### DESCRIPTION OF EXEMPLARY EMBODIMENTS

The best mode for implementing the present invention will be described in detail hereunder by reference to the drawings.

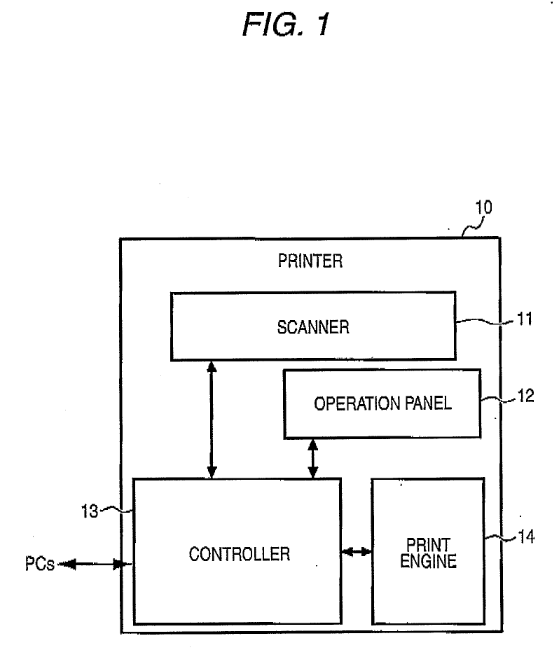

First, the configuration of a printer 10 of an embodiment of the present invention will be described by reference to FIG. 1.

As shown in FIG. 1, the printer 10 of the present embodiment is a device having a scanner 11, an operation panel 12, a controller 13, and a print engine 14, which is a so-called multifunction machine.

The operation panel 12 is a unit provided on the printer 10 for receiving various instructions from the user and submitting the status of the printer 10 to the user. The operation panel 12 includes an LCD, a plurality of LEDs, a plurality of push button switches, and the like.

The print engine 14 is a unit for subjecting a sheet to printing. The scanner 11 generates image data pertaining to an original by means of scanning the original set on the scanner.

The controller 13 controls respective sections in the printer 10 in a consolidated manner for causing the printer 10 to act as a multifunction machine. The controller 13 has the same hardware configuration as that of the related-art controller. Therefore, descriptions about the specific hardware configuration of the controller 13 are omitted, but the printer 10 includes a slot for USB memory provided in a housing thereof. The controller 13 is arranged so as to be able to subject USB memory inserted into the slot to reading/writing. Further, the controller 13 includes a restarting circuit, which is a circuit that is constituted of a power IC having ON/OFF function, a capacitor, and the like, for restarting the printer 10.

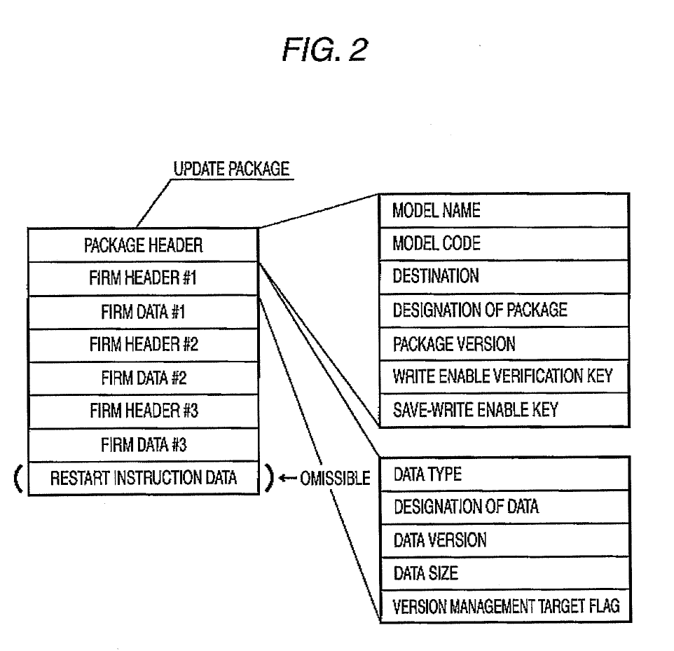

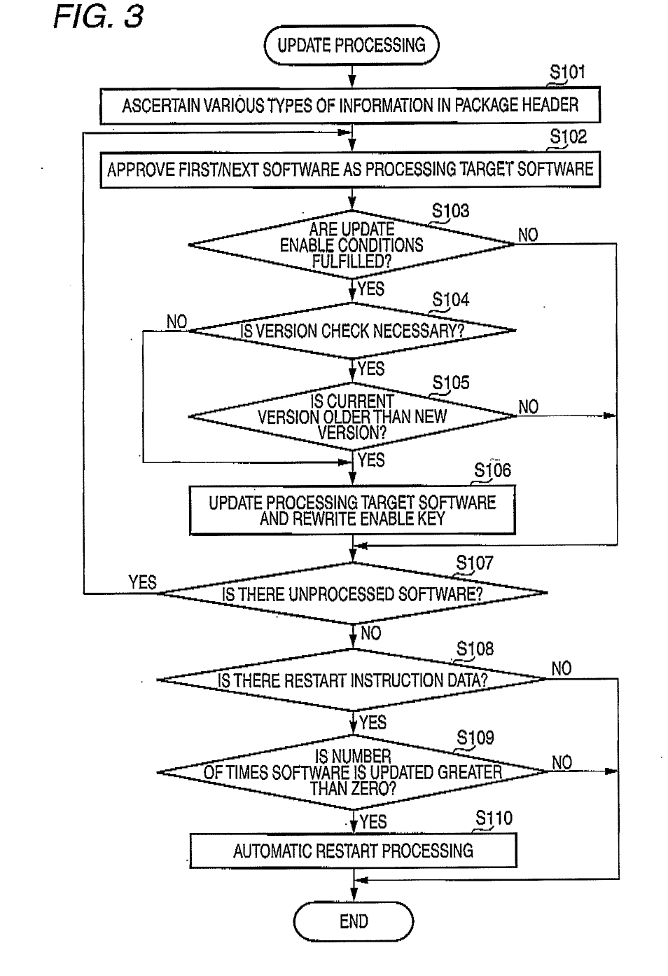

Operation of the printer 10 of the embodiment will now be described by reference to FIGS. 2 and 3.

The controller 12 provided in the printer 10 is a unit programmed in such a way that version information about respective pieces of software which is information showing versions of software and an enable key (which will be described in detail later) are stored (saved) in ROM which is flash ROM along with various types of software including firmware and set data for various applications for controlling a print engine, for controlling a scanner, and the like.

The controller 12 is embodied as a unit programmed so as to commence update processing for updating various types of software when an update package is transmitted from a PC and when USB memory where an update package is stored is attached (inserted into the slot formed in the housing).

The update package is information having a data configuration shown in FIG. 2.

Specifically, the update package is information configured so as to be able to enable appending of several pairs, each of which includes a firm header and firm data (software itself to be updated) including the designation of data, a data version, a version management target flag, and the like, to a package header including a write enable verification key, a save-write enable key, and the like; and to include restart instruction data of predetermined specifics in the end of the package.

The write enable verification key included in the package header of the update package is information, in which each byte is used as a verification key (to be described in detail later) pertaining to each of pieces of software (hereinafter described as “packaged software”) whose firm headers and firm data are included in the update package. The write enable verification key is 8-byte information in the embodiment. The save-write enable key included in the package header is information, in which each of bytes is used as a new enable key (details of which will be described later) pertaining to respective pieces of the packaged software. The save-write enable key is 8-byte information in the present embodiment. The designation of data included in the firm header of the update package is the designation of firm data appended to the firm header and is identification information about the firmware to be updated, and the data version is information showing the version of the firm data. The version management target flag is information for designating whether or not to ascertain version update at the time of updating of the corresponding firmware.

The controller 13 performs processing whose basic processing procedures are provided in FIG. 3 as the foregoing update processing. In the following descriptions, software is depicted simply as “soft.”

Specifically, when imparted with an update package to be processed, the controller 13 ascertains various types of information in the package header of the update package (step S101) and performs processing (step S102) for specifying the first software which is soft indicated by the designation of data in the first firm header in the update package, as processing target software.

Subsequently, the controller 13 determines whether or not a combination of an enable key pertaining to processing target software which is information recorded in ROM and a verification key pertaining to the processing target software, which is 1-byte information about the processing target software in the write enable verification key in the package header, fulfills update enable conditions (step S103).

The update enable conditions correspond to conditions [“(a verification key AND an enable key) EOR enable key=“000000000”]; (a verification key AND an enable key) EOR enable key is a result of logical operation acquired for each bit) in the present embodiment) defined in software which is software that can be updated through update processing for causing the controller 13 to execute update processing. Any conditions can be used as the update enable conditions, so long as the conditions are sometimes not fulfilled depending on a combination of the enable key and the verification key. As used in the present embodiment, it is desirable that a verification key, by means of which conditions are fulfilled regardless of a value of an enable key, is present (ALL 1 at (a verification key AND an enable key) EOR enable key=“000000000”).

When the combination of the enable key and the verification key does not fulfill the update enable conditions (NO in step S103), the controller 13 determines whether or not unprocessed software (an unprocessed firm header and unprocessed firm data) are left (step S107). When unprocessed software is left (YES in step S107), processing returns to step S102, where processing for the next software is commenced.

When the combination of the enable key and the verification key fulfills the update enable conditions (YES in step S103), the controller 13 determines whether or not it is necessary to perform a version check (step S104). On the other words, the controller 13 determines whether or not aversion processing target flag pertaining to processing target software is information designating a necessity for ascertaining that version processing is version update.

When it is not necessary to perform the version check (NO in step S104), the controller 13 actually updates the processing target software and performs processing (step S106) for rewriting an enable key pertaining to processing target software to a new enable key, which is 1-byte information about processing target software in a save-write enable key in the package header, and subsequently commences processing pertaining to step S107 and subsequent steps. Processing pertaining to step S106 is embodied as processing for which the number of times processing is performed is counted.

In contrast, when it is necessary to perform the version check (YES in step S104), the controller 13 compares the current version information (information in the ROM) pertaining to the processing target software with the new version information (a data version in the firm header), thereby determining whether or not a software update performed on the basis of the firm data in the update package corresponds to a version update of the processing target software (step S105). When the software update corresponds to the version update (YES in step S105), the controller 13 performs processing pertaining to step S106, and processing subsequent to step S107 is commenced. When the software update does not correspond to the version update (NO in step S105), processing pertaining to step S107 and subsequent steps is initiated without performance of processing pertaining to step S106.

When completed processing of software in all of the packages (NO in step S107), the controller 13 determines whether or not the update package being processed includes restart instruction data (step S108).

When the update package includes restart instruction data (YES in step S108), the controller 13 determines whether or not the number of pieces of updated software is one or more (whether or not the number of times processing pertaining to step S106 is performed is one or more) (step S109). When the number of pieces of updated software is one or more (YES in step S109), automatic restart processing that is processing for causing the restart circuit to operate (step S110) is performed, and update processing is completed.

When the restart instruction data are not included in the update package (NO in step S108) and when the number of pieces of updated software is zero despite the fact that the update package includes the restart instruction data (NO in step S109), the controller 13 completes update processing without performance of automatic restart processing.

As is evident from the above descriptions, the printer 10 of the embodiment is embodied as a device that, when an update package to be processed is imparted, determines software to be actually updated (software taken as a target of processing pertaining to step S106) on the basis of a verification key pertaining to each of pieces of software in the update package and an enable key pertaining to each of pieces of software in the apparatus (in the ROM of the controller). The printer 10 is also embodied as a device that, when updating certain software, rewrites an enable key in the apparatus pertaining to the software to a new enable key pertaining to the software (a value of a specific one byte of the save-write enable key in the package header).

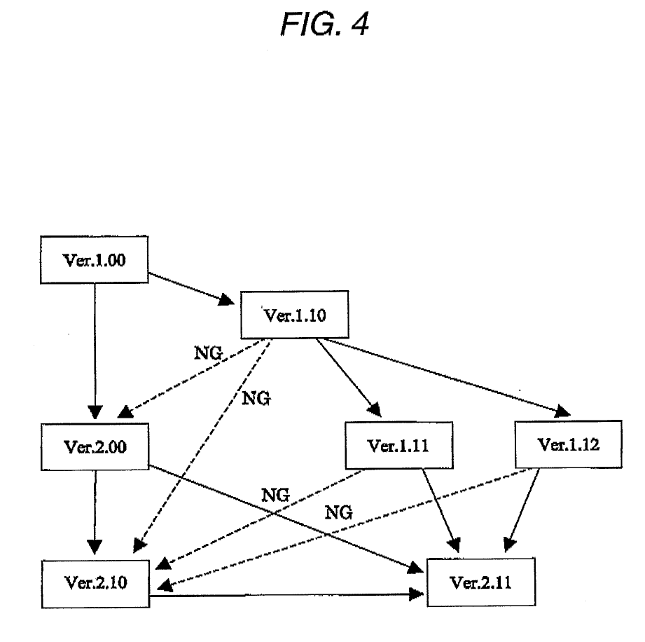

Therefore, so long as the printer 10 is designated such that, every time an update package is generated, a new enable key pertaining to each of pieces of software comes to an appropriate value (a value conforming to specifics of an update to be subsequently performed), the printer can be said to be a device (i.e., a device enabling a more accurate software update) capable of generating a package during subsequent generation of an update package, such as that exemplified in FIG. 4; namely, a device capable of generating a package for updating software to a version 2.10 and a package for updating software to version 2.110 (a package for not updating software of a specific version/a package for updating only software of a specific version).

<<Modified Mode>>

Various modifications can be made to the printer 10. For instance, the printer 10 or the software for causing the printer 10 to perform update processing (hereinafter described as “update processing software”) can be modified into a device or software that makes a determination as to step S105 (a determination as to whether or not update processing is a version update) at all times (a device or software that does not make a determination pertaining to step S104) or a device or software that does not make a determination as to step S105 (and S104) at all times. When the printer 10/the update processing software is arranged so as to make a determination as to step S105 at all times, intentional version downgrade of software cannot be carried out. When the printer 10/the update processing software is arranged so as not to make a determination as to step S105 at all times, an undesirable version downgrade of software may also be performed. For these reasons, it is desirable that the printer 10/the update processing software is arranged so as to make a determination as to steps S104 and S105.

Naturally, the printer 10/the update processing software can also be modified so as to take, as a processing target, an update package having a data configuration differing from that mentioned above (e.g., an update package whose new enable key is information in a firm header or an update package whose restart instruction data correspond to information in a package header), or the printer 10 can also be modified so as to have a hardware configuration differing from that mentioned above.

What is claimed is:

1. A printer comprising:
a nonvolatile storage unit, storing a plurality of types of software and enable keys for the respective pieces of the software; and
a software update unit, when update information including several pieces of software and verification keys and new enable keys for the respective pieces of the software is provided,
determining, whether or not the enable key in the nonvolatile storage unit pertaining to the corresponding software has a predetermined relationship with the verification key in the update information, with respect to each of the pieces of the software in the update information, and
performing rewrite processing for rewriting the software and the enable key in the nonvolatile storage unit respectively to the software and the new enable key in the update information, with respect to each of the pieces of the software for which the enable key has the predetermined relationship with the verification key.

2. The printer according to claim 1, wherein:
the update information includes information about each of the pieces of the software including version information showing a version of the software;
the nonvolatile storage unit stores, for each of the pieces of the software, version information showing a version of the software; and
the software update unit,
determining whether or not the version information about the corresponding software in the nonvolatile storage unit is older than the version information in the update information, with respect to each of the pieces of the software in the update information, and
performing the rewrite processing for rewriting the software, the enable key, and the version information in the nonvolatile storage unit respectively to the software, the new enable key, and the version information in the update information, with respect to each of the pieces of the software for which the enable key has the predetermined relationship with the verification key and for which the version information in the nonvolatile storage unit is older than the version information in the update information.

3. The printer according to claim 2, wherein:
the update information includes information for designating whether or not a version check about the version of each of the pieces of the software is required; and
the software update unit performs the rewrite processing, with respect to each of the pieces of the software for which the enable key has the predetermined relationship with the verification key and for which the version check is not required.

4. The printer according to claim 1, further comprising:
a restart unit, restarting the printer, wherein
the software update unit causes the restart unit to function after completion of processing in relation to the update information when the write processing is performed one or more times.

5. The printer according to claim 4, wherein
the software update unit causes the restart unit to function when the update information includes predetermined restart instruction information and the write processing is performed One or more times.

6. A printer, comprising:
a storage, storing first software and a first key for the first software; and
a controller, when update information including second software, a verification key for the second software and a second key for the second software is provided,
operable to determine whether or not a relationship between the first key and the verification key fulfills a predetermined condition, and
operable to rewrite the first software and the first key to the second software and the second key, when the relationship between the first key and the verification key fulfills the predetermined condition.

7. The printer according to claim 6, wherein
the storage stores third software and a third key for the third software which is different from the first key, and
a relationship between the third key and the verification key does not fulfills the predetermined condition.
